(19) United States
(12) Patent Application Publication
(10) Pub. No.: US 2025/0039308 A1
(43) Pub. Date: Jan. 30, 2025

(54) IMAGE FORMING APPARATUS AND STORAGE MEDIUM

(71) Applicant: CANON KABUSHIKI KAISHA, Tokyo (JP)

(72) Inventor: MASATOSHI YOSHIDA, Shizuoka (JP)

(21) Appl. No.: 18/777,941

(22) Filed: Jul. 19, 2024

(30) Foreign Application Priority Data
Jul. 25, 2023 (JP) 2023-120925

(51) Int. Cl. H04N 1/00; B65H 43/04

(52) U.S. Cl. CPC H04N 1/00037; B65H 43/04

(57) ABSTRACT

An image forming apparatus includes a detection unit, arranged on a conveyance path, configured to detect a characteristic value indicating a physical characteristic of a sheet currently conveyed on the conveyance path from a storage unit toward an image forming unit. The apparatus obtains boundary information based on a change in the detected characteristic value while discrete sheets in the sheet stack are sequentially conveyed from the storage unit. The boundary information indicates a boundary between different types of sheets in the sheet stack that has been stored in the storage unit. In a case where a defect has occurred in the apparatus, the apparatus discriminate a defect that occurs due to mixed stacking based on the obtained boundary information, the mixed stacking being stacking of a plurality of types of sheets in the storage unit.

### BACKGROUND OF THE INVENTION

### Field of the Invention

The present invention relates to an image forming apparatus and a management system.

### Description of the Related Art

Today, in the market of image forming apparatuses, which include laser printers as typical examples, there have been increasing occasions where a company signs a contract, such as a contract on maintenance of an image forming apparatus, with a user. For a company that performs maintenance and management of an image forming apparatus under such a contract (a maintenance and management company), when a defect has occurred in the image forming apparatus, it is desirable that the defect be efficiently resolved without requiring a service dispatch that involves a direct visit to the site of installation of the image forming apparatus. For example, in a case where a defect has occurred due to mixed stacking of a plurality of different types of sheets in a sheet storage unit, suggesting a user to dissolve the state of mixed stacking of sheets in the sheet storage unit can resolve the defect without requiring a service dispatch.

Japanese Patent Laid-Open No. 2021-33013 suggests a technique to control the temperature of a fixing unit, which fixes an image on a sheet in an image forming apparatus, at a fixing temperature corresponding to a sheet type that has been detected using a medium sensor. This technique may be able to obviate poor fixing caused by mixed stacking of a plurality of types of sheets in a sheet storage unit.

However, on the occurrence of a defect caused by mixed stacking of a plurality of types of sheets in a sheet storage unit (e.g., a sheet jam on a conveyance path), the aforementioned conventional technique cannot discriminate mixed stacking of sheets as the cause of the defect. In this case, it is not possible to suggest a user to dissolve the state of mixed stacking of sheets in the sheet storage unit, and a situation may arise where, for example, a maintenance and management company needs to engage in a service dispatch to resolve the defect.

### SUMMARY OF THE INVENTION

In view of the above, the present disclosure provides a technique to enable discrimination of a defect caused by mixed stacking of sheets in a storage unit in a case where a defect has occurred in an image forming apparatus.

According to one aspect of the present invention, there is provided an image forming apparatus, comprising: a storage unit in which a sheet stack is stored; an image forming unit configured to form an image on a sheet conveyed from the storage unit via a conveyance path; a detection unit arranged on the conveyance path, and configured to detect a characteristic value indicating a physical characteristic of a sheet currently conveyed on the conveyance path from the storage unit toward the image forming unit; an obtainment unit configured to obtain boundary information based on a change in the characteristic value detected by the detection unit while discrete sheets in the sheet stack are sequentially conveyed from the storage unit, the boundary information indicating a boundary between different types of sheets in the sheet stack that has been stored in the storage unit; and a discrimination unit configured to, in a case where a defect has occurred in the image forming apparatus, discriminate a defect that occurs due to mixed stacking based on the boundary information obtained by the obtainment unit, the mixed stacking being stacking of a plurality of types of sheets in the storage unit.

According to another aspect of the present invention, there is provided an image forming apparatus, comprising: a storage unit in which a sheet stack is stored; an image forming unit configured to form an image on a sheet conveyed from the storage unit via a conveyance path; a first sensor arranged in a vicinity of a curved portion of the conveyance path, the first sensor detecting a sheet currently conveyed on the conveyance path from the storage unit toward the image forming unit; an obtainment unit configured to obtain boundary information based on a change in a time period which is required to convey a sheet in a predetermined section of the conveyance path and which is measured using an output from the first sensor, the boundary information indicating a boundary between different types of sheets in the sheet stack that has been stored in the storage unit; and a discrimination unit configured to, in a case where a defect has occurred in the image forming apparatus, discriminate a defect that occurs due to mixed stacking based on the boundary information obtained by the obtainment unit, the mixed stacking being stacking of a plurality of types of sheets in the storage unit.

According to still another aspect of the present invention, there is provided a management system, comprising: an image forming apparatus; and a management apparatus that is capable of communicating with the image forming apparatus via a network and manages the image forming apparatus, wherein the image forming apparatus comprises: a storage unit in which a sheet stack is stored; an image forming unit configured to form an image on a sheet conveyed from the storage unit via a conveyance path; a detection unit arranged on the conveyance path, and configured to detect a characteristic value indicating a physical characteristic of a sheet currently conveyed on the conveyance path from the storage unit toward the image forming unit; an obtainment unit configured to obtain boundary information based on a change in the characteristic value detected by the detection unit while discrete sheets in the sheet stack are sequentially conveyed from the storage unit, the boundary information indicating a boundary between different types of sheets in the sheet stack that has been stored in the storage unit; and a discrimination unit configured to, in a case where a defect has occurred in the image forming apparatus, discriminate a defect that occurs due to mixed stacking based on the boundary information obtained by the obtainment unit, the mixed stacking being stacking of a plurality of types of sheets in the storage unit, and wherein the image forming apparatus further includes a notification unit configured to notify the management apparatus of the result of the discrimination of the defect by the discrimination unit.

Further features of the present invention will become apparent from the following description of exemplary embodiments (with reference to the attached drawings).

### BRIEF DESCRIPTION OF THE DRAWINGS

FIG. 1 is a cross-sectional diagram of exemplary hardware components of an image forming apparatus.

FIG. 2 is a block diagram showing an example of a schematic control configuration of the image forming apparatus.

FIGS. 3A to 3D are cross-sectional diagrams of exemplary components in the vicinity of a storage unit and a feeding unit.

FIGS. 4A to 4C show exemplary components of a detection device.

FIG. 5 shows an example of a mixed stacking state of sheets in the storage unit.

FIG. 6 shows an exemplary distribution of characteristic values indicating the grammages and surface properties of sheets.

FIG. 7 shows an example of a mixed stacking index value Z obtained based on an output from the detection device.

FIG. 8 is a flowchart showing an example of a procedure of processing for discriminating the cause of a defect that has occurred in the image forming apparatus.

FIG. 9 is a cross-sectional diagram of exemplary components in the vicinity of the storage unit and the feeding unit (a second embodiment).

FIG. 10 shows examples of changes in a time period t until a sheet reaches a conveyance sensor on a conveyance path (the second embodiment).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

A laser beam printer (LBP) of an electrophotographic method will now be described as one example of an image forming apparatus according to embodiments of the present disclosure. Note that the image forming apparatus is not limited only to a laser beam printer, and may be another type of image forming apparatus, such as a printer, a copier, a facsimile apparatus, and an inkjet printer.

### <Configuration of Image Forming Apparatus>

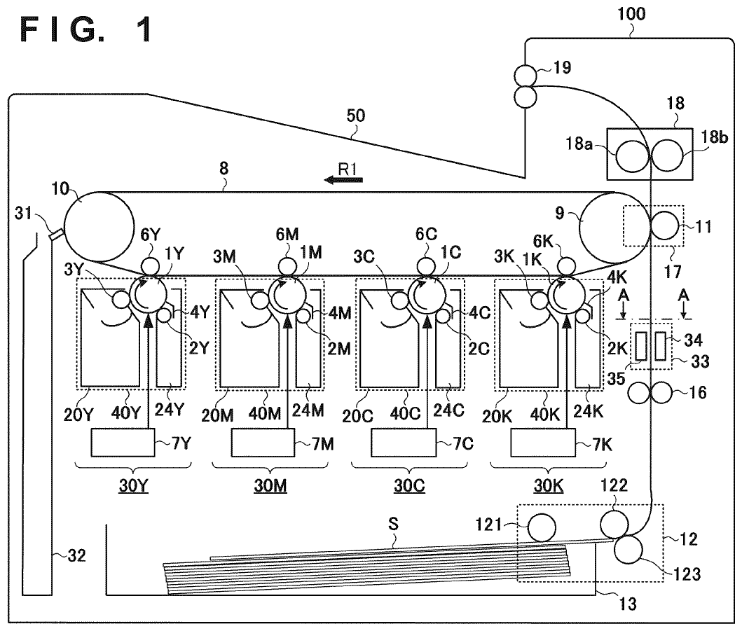

FIG. 1 is a cross-sectional diagram of exemplary hardware components of an image forming apparatus 100 according to an embodiment of the present disclosure. The image forming apparatus 100 is configured to form an image on a recording material using an electrophotographic method. Furthermore, the image forming apparatus 100 is configured as an inline laser beam printer that adopts an intermediate transfer method, and is capable of forming a full-color image. The image forming apparatus 100 uses an intermediate transfer belt as an intermediate transfer member. Note that the image forming apparatus may be configured as a laser beam printer that adopts a direct transfer method in which a toner image is transferred from a photosensitive member (photosensitive drum) to a recording material without intervention of an intermediate transfer member (intermediate transfer belt). Note that a recording material on which an image is to be formed may be referred to as a sheet, recording paper, a recording medium, a sheet of paper, a transfer material, transfer paper, or the like. The following describes an example in which an image is formed on a sheet.

The image forming apparatus 100 includes image forming units 30Y, 30M, 30C, and 30K as a plurality of image forming units that respectively form images (toner images) in different colors. The image forming units 30Y, 30M, 30C, and 30K are aligned in this order from the upstream side to the downstream side along a moving direction R1 of a surface of an intermediate transfer belt 8 on which toner images are carried. The image forming units 30Y, 30M, 30C, and 30K respectively form images using toner in colors yellow, magenta, cyan, and black. The image forming units 30Y, 30M, 30C, and 30K are configured in the same manner. Note that the letters Y, M, C, and K appended to reference numerals indicate toner colors of yellow (color Y), magenta (color M), cyan (color C), and black (color K), and will be omitted in a description of matters that are common to these colors.

The image forming units 30 include a process cartridge 40 that is attachable to and detachable from the image forming apparatus 100. The process cartridge 40 includes a photosensitive drum 1, a charging roller 2, a development unit 20 provided with a development roller 3, a cleaning blade 4, and a toner waste container 24. The development unit 20 includes the development roller 3. The image forming units 30 further include a primary transfer roller 6 and a laser unit 7. The primary transfer roller 6 is arranged at a position which is on the inner side of the intermediate transfer belt 8, and which opposes the photosensitive drum 1 via the intermediate transfer belt 8. The laser unit 7 is placed below the process cartridge 40.

The photosensitive drum 1 is an image carrier that carries an electrostatic latent image and a toner image that has been formed by developing this electrostatic latent image using toner. The photosensitive drum 1 is driven so as to rotate in an arrow direction shown in FIG. 1 (clockwise direction) at a predetermined circumferential velocity (circumferential speed).

The charging roller 2 uniformly charges the surface of the photosensitive drum 1, by a predetermined charging voltage being applied from a power source (not shown). The laser unit 7 forms an electrostatic latent image on the surface of the photosensitive drum 1 by exposing the photosensitive drum 1 to light based on image signals (image data). The development roller 3 forms a toner image on the photosensitive drum 1 by developing the electrostatic latent image formed on the photosensitive drum 1 using a developer (toner) supplied from a toner container inside the development unit 20. Specifically, toner on the development roller 3 moves and adheres to the photosensitive drum 1, by a predetermined development voltage being applied from a power source (not shown) to the development roller 3. As a result, the electrostatic latent image on the photosensitive drum 1 is developed as a toner image.

The image forming apparatus 100 includes the intermediate transfer belt 8 which is positioned so as to oppose each photosensitive drum 1, and which is in the form of a flexible endless belt. The intermediate transfer belt 8 is hung in a stretched state around a driving roller 9 for rotating the intermediate transfer belt 8 and a driven roller 10 for applying appropriate tension to the intermediate transfer belt 8. A driving motor (not shown) transmits a driving force to the driving roller 9; as a result, the intermediate transfer belt 8 is driven so as to rotate in the direction of arrow R1 (counterclockwise direction) while in contact with the photosensitive drums 1. The intermediate transfer belt 8 moves at a speed corresponding to the circumferential velocity of the photosensitive drums 1.

On the inner side of the intermediate transfer belt 8, the primary transfer rollers 6 are arranged as transfer members that transfer toner images from the photosensitive drums 1 to the intermediate transfer belt 8. The toner images formed on the photosensitive drums 1 are transferred to the intermediate transfer belt 8 at transfer positions (primary transfer portion), by a primary transfer voltage being applied from a power source (not shown) to the primary transfer rollers 6; as a result. For example, a positive-polarity voltage is applied to the intermediate transfer belt 8 via the primary transfer rollers 6; as a result, negative-polarity toner images are transferred from the photosensitive drums 1 to the intermediate transfer belt 8. At this time, the toner images in four colors, namely color Y, color M, color C, and color K, that have been respectively formed on the photosensitive drums 1Y, 1M, 1C, and 1K are successively transferred to the intermediate transfer belt 8 in such a manner that they overlap one another.

In accordance with rotation of the intermediate transfer belt 8, the toner images formed on the intermediate transfer belt 8 are conveyed to a secondary transfer unit 17, which forms a site of contact between the intermediate transfer belt 8 and a secondary transfer roller 11. In the secondary transfer unit 17, the toner images on the intermediate transfer belt 8 are transferred to a sheet S that has been conveyed on a conveyance path from a storage unit (sheet storage unit) 13.

Sheets S are stored in the storage unit 13 in a stacked state. A feeding unit 12 includes a pickup roller 121, a feed roller 122, and a separation roller 123. The pickup roller 121 is configured to perform a pickup operation to feed the sheets S stacked in the storage unit 13 toward the conveyance path. The feed roller 122 is configured to convey the sheets S that have been fed from the storage unit 13 to the conveyance path, toward a registration roller pair 16. The separation roller 123 is configured to perform a sheet separation operation so that the sheets S fed from the storage unit 13 are conveyed by the feed roller 122 one by one.

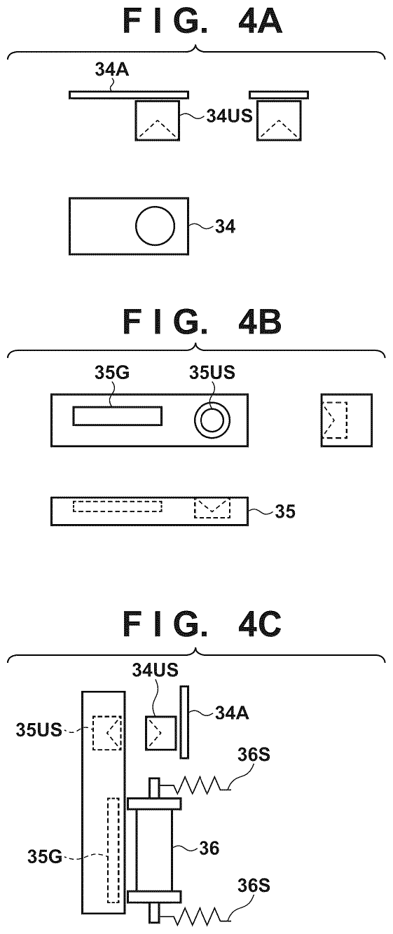

The image forming apparatus 100 includes a detection device 33 that is arranged on the conveyance path from the feeding unit 12 to the registration roller pair 16. The detection device 33 detects characteristic values indicating physical characteristics of the sheets conveyed on the conveyance path (physical characteristic values). In the present embodiment, the detection device 33 is configured to detect, as physical characteristic values of the sheets, physical characteristic values indicating the grammage and surface property of the sheets. Exemplary components of the detection device 33 will be described later using FIGS. 4A to 4C.

A sheet S conveyed to the registration roller pair 16 is to be conveyed to the secondary transfer unit 17 by the registration roller pair 16 at a predetermined control timing and at a speed corresponding to the rotation speed of the intermediate transfer belt 8. The toner images on the intermediate transfer belt 8 are transferred to the sheet S in the secondary transfer unit 17, by a secondary transfer voltage being applied from a power source (not shown) to the secondary transfer roller 11. For example, a positive-polarity voltage is applied to the sheet S via the secondary transfer roller 11; as a result, negative-polarity toner images are transferred from the intermediate transfer belt 8 to the sheet S.

The sheet S to which the toner images have been transferred in the secondary transfer unit 17 is conveyed to a fixing unit 18. The fixing unit 18 includes a fixing roller 18a, which is a heating member, and a pressurizing roller 18b, which is a pressurizing member arranged to oppose the fixing roller 18a. The fixing unit 18 executes fixing processing for fixing the transferred toner images to the sheet S by applying heat and pressure to the sheet S while the sheet S is passing through a site of contact between the fixing roller 18a and the pressurizing roller 18b. The sheet S that has undergone the fixing processing is discharged onto a discharge tray 50 by a discharge roller pair 19.

The cleaning blade 4 removes toner remaining on the surface of the photosensitive drum 1 after the toner image has been transferred from the photosensitive drum 1 to the intermediate transfer belt 8. While in contact with the photosensitive drum 1, the cleaning blade 4 collects toner on the photosensitive drum 1 into the toner waste container 24. Also, a cleaning blade 31 removes toner remaining on the surface of the intermediate transfer belt 8 after the toner images have been transferred from the intermediate transfer belt 8 to the sheet S, and paper dust moved from the sheet S to the intermediate transfer belt 8 during this transfer. While in contact with the intermediate transfer belt 8, the cleaning blade 31 collects toner and paper dust on the intermediate transfer belt 8 into a toner waste container 32.

In the present embodiment, the image forming units 30, the secondary transfer unit 17, and the fixing unit 18 function as examples of an image forming unit that forms an image on a sheet conveyed from the storage unit 13 through the conveyance path.

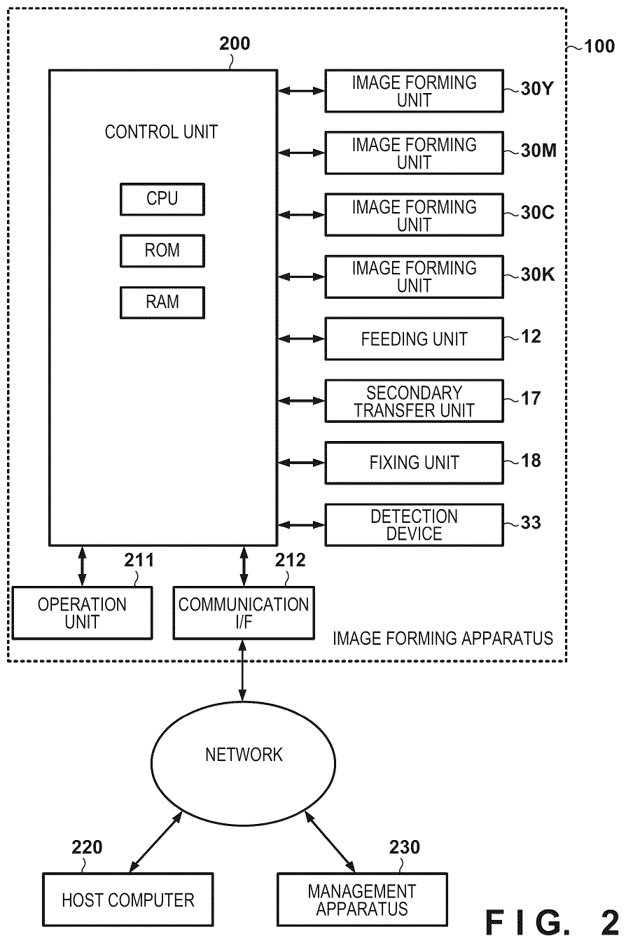

FIG. 2 is a block diagram showing an example of a schematic control configuration of the image forming apparatus 100. The image forming apparatus 100 further includes a control unit 200, an operation unit 211, and a communication interface (I/F) 212. The control unit 200 controls the operations of the entire image forming apparatus 100 by controlling the operations of devices inside the image forming apparatus 100.

The control unit 200 includes a processor (CPU), a ROM, and a RAM. The ROM is a nonvolatile storage that stores a program, such as a control program for controlling the operations of the image forming apparatus 100. The RAM is a volatile storage that is used as a temporary storage area for the program and data, and a working area for the CPU. The CPU controls the operations of each device (the image forming units 30 and the like) of the image forming apparatus 100 by reading the program stored in the ROM into the RAM and executing the program.

The operation unit 211 includes an input unit and a display unit. The input unit includes input devices, such as a touch panel and hardware keys, and accepts various types of operations from a user. The display unit includes a display device, such as a liquid crystal display, and outputs (displays) various types of information for the user. The communication I/F 212 is an interface for performing communication with external apparatuses via a network.

The communication I/F 212 may be composed of an interface that performs wired communication, or may be composed of an interface that performs wireless communication (e.g., wireless LAN communication). As shown in FIG. 2, the communication I/F 212 can communicate with external apparatuses such as a host computer 220 and a management apparatus 230, via the network. Note that, as will be described later, the management apparatus 230 is an information processing apparatus (server apparatus) that plays a role in managing the image forming apparatus 100. In the present embodiment, the management apparatus 230 is one example of a management apparatus that can communicate with the image forming apparatus 100 via the network and that manages the image forming apparatus 100. The image forming apparatus 100 and the management apparatus 230 can compose a management system.

Upon receiving a print job from the host computer 220, the control unit 200 obtains image data that can be used in image formation by decompressing print data included in this print job. The control unit 200 has a function of executing processing for placing character codes into a bitmap format, or image processing such as image halftoning processing, with respect to the image data received from the host computer 220. The control unit 200 controls the image forming units 30Y, 30M, 30C, and 30K so as to perform an image forming operation of forming an image on a sheet S based on the decompressed image data.

### <Example of Sheet Feeding Operation>

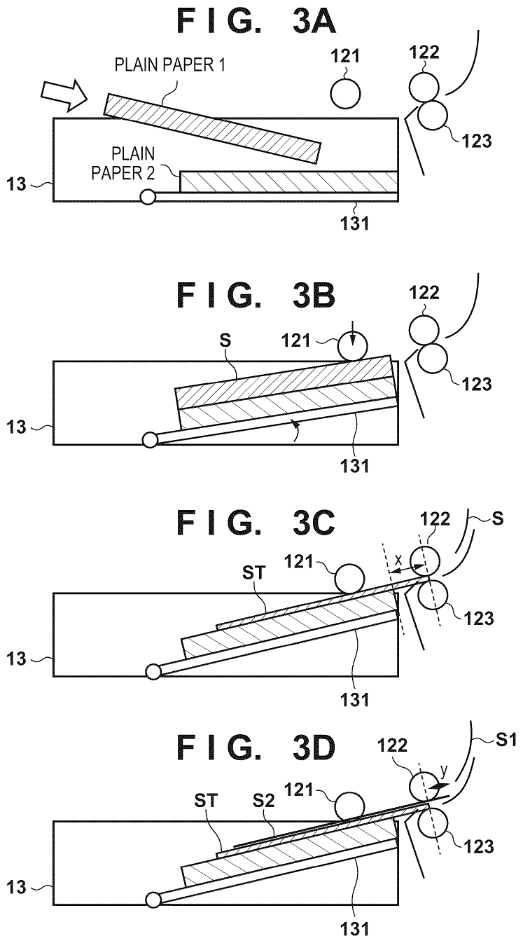

With reference to FIGS. 3A to 3D, a description is now given of an example of a sheet feeding operation for a case where a plurality of different types of sheets are stacked in the storage unit 13 (mixed stacking) and then the sheets are sequentially fed from the storage unit 13 by the feeding unit 12. FIGS. 3A to 3D are cross-sectional diagrams of exemplary components in the vicinity of the storage unit 13 and the feeding unit 12 in the image forming apparatus 100. Note that in the present specification, “mixed stacking” refers to stacking of a plurality of different types of sheets in the same storage unit (storage compartment).

FIG. 3A shows a state where sheets (a stack of sheets) of plain paper 1 and sheets (a stack of sheets) of plain paper 2 are mixedly stacked in the storage unit 13. In the present example, the stack of sheets of plain paper 2 is loaded first in the storage unit 13, and then the stack of sheets of plain paper 1, which has a different sheet type from plain paper 2, is loaded thereon. Note that several tens of sheets of plain paper 1 and several tens of sheets of plain paper 2 are stacked. This results in a state where the plurality of different types of sheets, namely plain paper 1 and plain paper 2, are mixedly stacked in the storage unit 13 (a mixed stacking state) as shown in FIG. 3B.

Here, the image forming apparatus 100 of the present embodiment has a plain paper mode corresponding to plain paper, and a thick paper mode corresponding to thick paper, as fixing temperature adjustment modes for the fixing unit 18. In the thick paper mode, a fixing temperature higher than a fixing temperature used in the plain paper mode is used. Both of plain paper 1 and plain paper 2 are classified into a category of “plain paper”, and correspond to the same fixing temperature adjustment mode (plain paper mode). On the other hand, plain paper 1 and plain paper 2 have different physical characteristics (grammage, surface property, etc.); thus, they are defined as different sheet types. Note that the grammage of a sheet is expressed in mass per unit area of the sheet (the unit is [g/m²]).

FIG. 3B shows a state immediately before the start of feeding of sheets from the storage unit 13. After the image forming operation has been started, the control unit 200 first lowers the pickup roller 121 in the direction of an arrow shown in FIG. 3B. Thereafter, the control unit 200 causes a lift-up plate 131 inside the storage unit 13 to exhibit an action of moving while turning in the direction of an arrow shown in FIG. 3B. Consequently, the sheets of plain paper 1 and plain paper 2 stacked on the lift-up plate 131 are raised, and a sheet of plain paper 1 comes into contact with the pickup roller 121. Once the topmost sheet S in the stack of sheets loaded in the storage unit 13 has come into contact with the pickup roller 121, the control unit 200 stops the action of the lift-up plate 131. This establishes a feeding position at which feeding of sheets is performed.

Thereafter, the control unit 200 causes the pickup roller 121 to start a pickup operation for propelling the topmost sheet S among the sheets stacked in the storage unit 13 toward the conveyance path. The sheet S that has been propelled by the pickup roller 121 from the storage unit 13 is conveyed to a nip portion between the feed roller 122 and the separation roller 123. The feed roller 122 conveys the sheet S propelled from the storage unit 13 on the conveyance path toward the registration roller pair 16. At this time, the separation roller 123 performs a sheet separation operation so that, even when a plurality of sheets have been propelled from the storage unit 13, the sheets are conveyed one by one. As a result of the foregoing feeding operation performed by the feeding unit 12, the sheets of plain paper 1 are fed sequentially from the storage unit 13.

FIG. 3C shows a state where the number of remaining sheets of plain paper 1 inside the storage unit 13 has become small, and all of the remaining sheets have been collectively conveyed (withdrawn), as a stack of sheets ST, from the storage unit 13 to the nip portion between the feed roller 122 and the separation roller 123. This state occurs due to a small coefficient of friction between the sheets of plain paper 1 and the sheets of plain paper 2. When the number of remaining sheets of plain paper 1 has decreased to a certain number (e.g., approximately 10), a state occurs where a conveyance force of the pickup roller 121 acting on these sheets exceeds a friction force generated on a boundary between the sheets of plain paper 1 and the sheets of plain paper 2. This results in the occurrence of a state where all of the remaining sheets of plain paper 1 are collectively withdrawn from the storage unit 13.

As shown in FIG. 3C, the stack of sheets ST is in a state where it has been conveyed from the storage unit 13 by a distance x and sandwiched between the feed roller 122 and the separation roller 123. The distance x is equivalent to a distance from the leading edges of the sheets of plain paper 2 stacked in the storage unit 13 to the nip portion between the feed roller 122 and the separation roller 123. Furthermore, the feed roller 122 and the separation roller 123 are in a state where they are separated from each other due to the thickness of the stack of sheets ST. If the feeding of sheets from the storage unit 13 is continued in this state, the separation roller 123 will not be able to fulfill its original function of separating the sheets from one another and conveying them one by one.

FIG. 3D shows a state immediately before a jam (paper jam) occurs with further feeding of sheets from the state of FIG. 3C. In a case where the separation roller 123 does not perform the sheet separation normally, a sheet S2 that is fed next to a preceding sheet S1 is withdrawn downstream in the conveyance direction along with the conveyance of the sheet S1, as shown in FIG. 3D. In the present example, the sheet S2 has been stopped in a state where the leading edge thereof has advanced downstream in the conveyance direction by a distance y from the position of the nip portion between the feed roller 122 and the separation roller 123.

If the feed roller 122 starts to convey the sheet S2 in this state, a sheet interval, which is defined as an interval between the trailing edge of the preceding sheet S1 and the leading edge of the succeeding sheet S2, becomes shorter than a designed interval by the distance y. In a case where the sheet interval has decreased and fallen below a designed allowable value in the foregoing manner, the image forming apparatus 100 (control unit 200) determines that it is difficult to continue an image forming process, stops the image forming operation, and provides a notification about the occurrence of a defect. In this case, the image forming apparatus 100 (control unit 200) provides a notification about the occurrence of a jam of a sheet currently conveyed (paper jam) as the defect.

As described above, in a case where a user of the image forming apparatus 100 has mixedly stacked a plurality of different types of sheets in the storage unit 13 as shown in FIG. 3A, such mixed stacking has the possibility of becoming the cause of the occurrence of a jam (defect) that accompanies feeding of sheets.

### <Exemplary Configuration of Detection Device>

Next, an exemplary configuration of the detection device 33 will be described using FIGS. 4A to 4C. As shown in FIG. 1, the detection device 33 includes a transmission unit 34 and a reception unit 35 that are arranged at positions that oppose each other via the conveyance path. FIG. 4A is a three-view diagram (a front view, a top view, and a side view) showing an exemplary configuration of the transmission unit 34. FIG. 4B is a three-view diagram (a front view, a top view, and a side view) showing an exemplary configuration of the reception unit 35. FIG. 4C shows an exemplary configuration of the entire detection device 33, including a pressing roller 36, in the form of a cross-section taken along A-A of FIG. 1.

In the detection device 33 of the present embodiment, the transmission unit 34 includes an electrical substrate 34A and an ultrasound transmitter 34US arranged on this substrate. The reception unit 35 includes an ultrasound receiver 35US and a light emitter 35G. As shown in FIG. 4C, the ultrasound transmitter 34US and the ultrasound receiver 35US are arranged at positions that oppose each other. Also, the pressing roller 36 is arranged at a position that opposes the light emitter 35G. The pressing roller 36 is pressed against the light emitter 35G by being pushed by pushing members 36S in the direction toward the light emitter 35G.

The control unit 200 discriminates a type of a sheet based on characteristic values indicating the physical characteristics (in the present embodiment, surface property and grammage) of the sheet detected by the detection device 33. The control unit 200 further determines image forming conditions based on the result of discrimination of the sheet type. The image forming conditions include, for example, a sheet conveyance speed, a voltage applied to the secondary transfer roller 11 (a secondary transfer voltage), fixing temperatures of the fixing unit 18, and the like.

The ultrasound transmitter 34US includes a piezoelectric element and an electrode terminal. The ultrasound transmitter 34US is configured in such a manner that the piezoelectric element oscillates as a result of application of a pulsed voltage with a predetermined frequency to the electrode terminal, thereby generating ultrasound. The ultrasound generated by the ultrasound transmitter 34US propagates through the air and reaches a sheet currently conveyed on the conveyance path; as a result, the ultrasound causes this sheet to vibrate. The ultrasound generated by the ultrasound transmitter 34US further propagates to the ultrasound receiver 35US via the sheet.

The ultrasound receiver 35US includes a piezoelectric element and an electrode terminal. The piezoelectric element of the ultrasound receiver 35US causes the electrode terminal to generate an output voltage corresponding to the amplitude of the received ultrasound. This output voltage changes in accordance with the transmittance at the time of transmission of the ultrasound through the sheet. With regard to a sheet with a high sheet grammage, the ultrasound transmittance is low, and the output voltage of the ultrasound receiver 35US is low. On the other hand, with regard to a sheet with a low sheet grammage, the ultrasound transmittance is high, and the output voltage of the ultrasound receiver 35US is high. The detection device 33 outputs the output voltage of the ultrasound receiver 35US as a detection result for a characteristic value indicating a sheet grammage. Meanwhile, the light emitter 35G is configured to irradiate a sheet that is currently conveyed on the conveyance path with light, and optically detect a characteristic value indicating the surface property of the sheet based on the distribution characteristics of light reflected by the sheet.

In the image forming apparatus 100 of the present embodiment, before the image formation on the sheet is started, the control unit 200 obtains the results of detection of characteristic values indicating the grammage and surface property of the sheet from the detection device 33, as characteristic values indicating the physical characteristics of the sheet. Based on the results of detection by the detection device 33, the control unit 200 discriminates the type of the sheet on which an image is to be formed, and determines image forming conditions based on the result of discrimination of the sheet type. Furthermore, the control unit 200 controls the image forming units 30 (30Y, 30M, 30C, and 30K), the secondary transfer unit 17, the fixing unit 18, and the like so that the image is formed in accordance with the determined image forming conditions.

<Examples of Outputs from Detection Device>

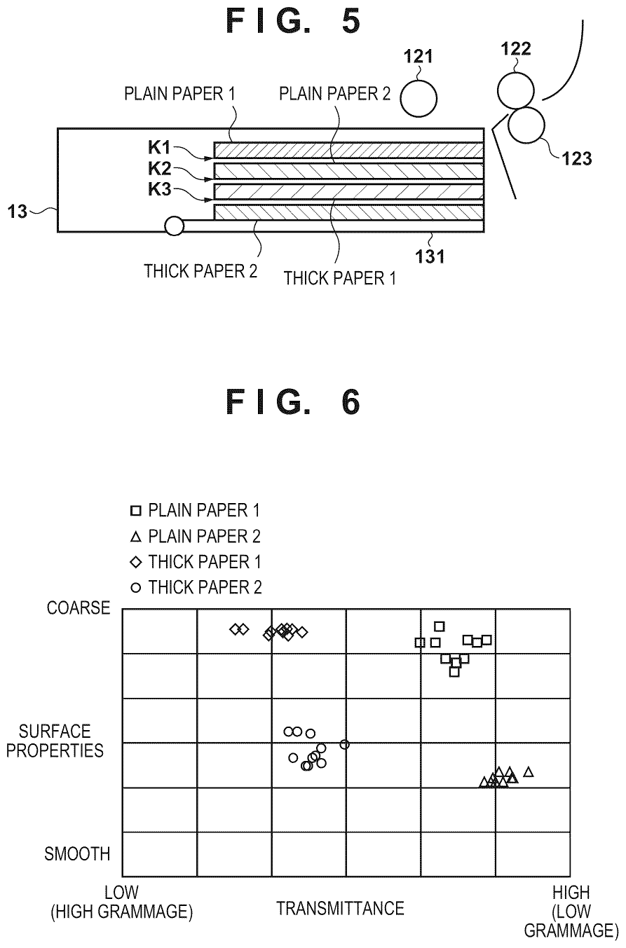

FIG. 5 shows an example of a mixed stacking state of sheets in the storage unit 13, which is the premise of the following description. In the present example, four different types of sheets are mixedly stacked inside the storage unit 13. Specifically, as shown in FIG. 5, a stack of sheets of thick paper 2 is loaded at the bottom, and stacks of sheets of thick paper 1, plain paper 2, and plain paper 1 are stacked thereon, in this order, in such a manner that the stacks overlie one another.

K1, K2, and K3 denote the numbers of counts (page counts) obtained by sequentially counting the sheets that are fed (conveyed), with the topmost sheet among all sheets stacked in the storage unit 13 serving as a reference (page count=1). K1 is a page count corresponding to the lowermost sheet (the sheet that is fed last) among the stack of sheets of plain paper 1, and indicates a boundary (mixed stacking boundary) between the stack of sheets of plain paper 1 and the stack of sheets of plain paper 2. K2 is a page count corresponding to the lowermost sheet among the stack of sheets of plain paper 2, and indicates a boundary (mixed stacking boundary) between the stack of sheets of plain paper 2 and the stack of sheets of thick paper 1. K3 is a page count corresponding to the lowermost sheet among the stack of sheets of thick paper 1, and indicates a boundary (mixed stacking boundary) between the stack of sheets of thick paper 1 and the stack of sheets of thick paper 2. (In the present specification, a boundary between sheet stacks that are composed of different types of sheets is also referred to as a “mixed stacking boundary”.) As described above, K1, K2, and K3 indicate the positions of the mixed stacking boundaries in the stack of sheets loaded (stored) in the storage unit 13. In the present example, it is assumed that 30 sheets of plain paper 1, plain paper 2, thick paper 1, and thick paper 2 each are stacked in the storage unit 13 (a total of 120 sheets are stacked therein). In this case, K1=30, K2=60, and K3=90.

FIG. 6 shows an exemplary distribution of characteristic values indicating the grammages and surface properties of sheets, which are detected by the detection device 33 while the sheets in the mixed stacking state shown in FIG. 5 are sequentially fed from the storage unit 13 and conveyed on the conveyance path. Note that the transmittance is used as a characteristic value indicating grammage.

As shown in FIG. 6, the transmittances of thick paper 1 and thick paper 2, which correspond to the thick paper mode as a fixing temperature adjustment mode, are distributed in an area of transmittances lower than the transmittances of plain paper 1 and plain paper 2, which correspond to the plain paper mode. In this way, the characteristic value indicating the grammage of a sheet (transmittance) changes depending on the sheet thickness. A lower transmittance indicates a larger sheet thickness, whereas a higher transmittance indicates a smaller sheet thickness. Based on the results of detection of such characteristic values indicating grammages by the detection device 33, it is possible to discriminate whether the type of a conveyed sheet is the type corresponding to the thick paper mode (thick paper 1 and thick paper 2) or the type corresponding to the plain paper mode (plain paper 1 and plain paper 2).

Furthermore, characteristic values indicating the surface properties of plain paper 1 and thick paper 1 are distributed in an area that corresponds to a coarser state than characteristic values related to plain paper 2 and thick paper 2. On the other hand, characteristic values indicating the surface properties of plain paper 2 and thick paper 2 are distributed in an area that corresponds to a smoother state than characteristic values related to plain paper 1 and thick paper 1. In the present example here, the sheets of plain paper 1 and thick paper 1 are sheets whose surfaces have large unevenness, such as bond paper. On the other hand, sheets of plain paper 2 and thick paper 2 are sheets whose surfaces have little unevenness, such as coated paper. Such sheet surface properties are reflected in the results of detection of characteristic values indicating the sheet surface properties shown in FIG. 6.

For example, it is possible to discriminate whether the type of a conveyed sheet is thick paper 1 or thick paper 2, or whether the type of a conveyed sheet is plain paper 1 or plain paper 2, based on the results of detection of characteristic values indicating such surface properties by the detection device 33. That is to say, it is possible to discriminate which one of the four types (plain paper 1, plain paper 2, thick paper 1, and thick paper 2) the sheet type is, based on the results of detection of characteristic values indicating the sheet grammages and on the results of detection of characteristic values indicating the sheet surface properties as shown in FIG. 6.

### <Obtainment of Mixed Stacking Index Value>

In the image forming apparatus 100 of the present embodiment, the control unit 200 obtains (determines) a mixed stacking index value, which will be described below, based on the results of detection of characteristic values indicating physical characteristics of sheets, which are output from the detection device 33. A mixed stacking index value is an index value of a mixed stacking state of sheets in the storage unit 13, and can be used in identifying a mixed stacking boundary and determining whether mixed stacking of sheets has occurred in the storage unit 13.

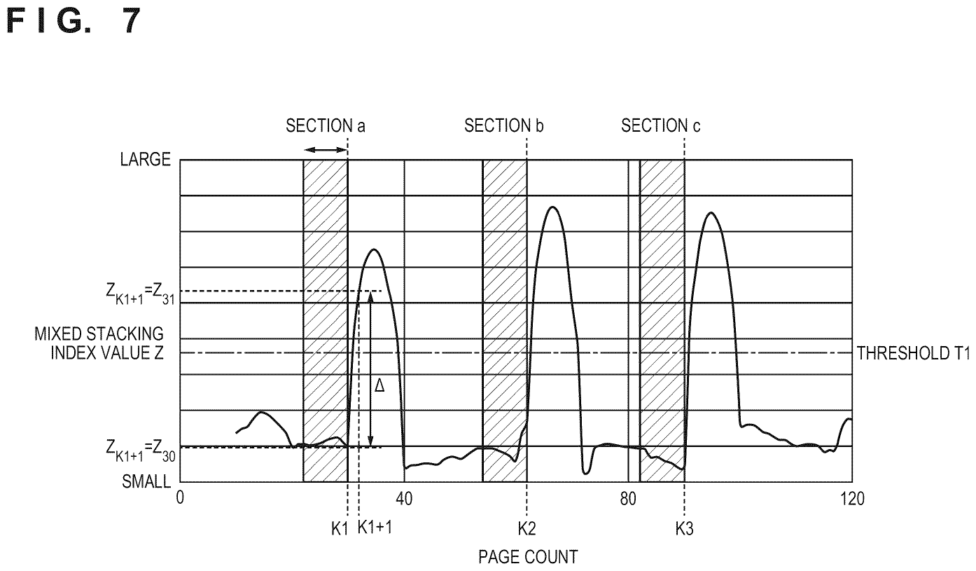

FIG. 7 shows an example of obtainment of a mixed stacking index value Z based on the results of detection of characteristic values indicating the grammages and surface properties by the detection device 33. The mixed stacking index value Z is obtained as follows. The present example represents an example of obtainment of the mixed stacking index value Z in a case where a total of 120 sheets including four different types of sheets are stacked (mixedly stacked) in the storage unit 13 as shown in FIG. 5, and an image forming process is performed by feeding all of these sheets sequentially from the storage unit 13.

First, with respect to characteristic values indicating the sheet grammages detected (output) by the detection device 33, a variance value over a predetermined number of sheets is obtained. Furthermore, with respect to the obtained variance value, a moving average value X over the predetermined number of sheets is obtained. In the present example, the predetermined number is 10. In this case, a total of 110 moving average values (X10, X11, . . . , X120) are obtained with respect to the total of 120 sheets to be processed. Note that, for example, X10 is a moving average value corresponding to the 10^{th} sheet, and X120 is a moving average value corresponding to the 120^{th} sheet.

Similar processing is executed also with respect to characteristic values indicating the sheet surface properties detected (output) by the detection device 33. Specifically, with respect to characteristic values indicating the sheet surface properties, a variance value over the predetermined number of sheets is obtained. Furthermore, with respect to the obtained variance value, a moving average value Y over the predetermined number of sheets is obtained. In the present example, as the predetermined number is 10 as stated earlier, a total of 110 moving average values (Y10, Y11, . . . , Y120) are obtained with respect to the total of 120 sheets to be processed. Note that, for example, Y10 is a moving average value corresponding to the 10^{th} sheet, and Y120 is a moving average value corresponding to the 120^{th} sheet.

The mixed stacking index value Z is obtained as a composite value of the aforementioned moving average values X and Y In the present embodiment, the sum of the moving average value X and the moving average value Y (i.e., Z₁₀=X10+Y10, Z₁₁=X11+Y11, . . . ) is obtained as the mixed stacking index value Z for each of the sheets that are sequentially fed. Note that the mixed stacking index value Z is not limited to the sum of the moving average value X and the moving average value Y on a per-sheet basis; for example, a product or a quotient of the moving average value X and the moving average value Y may be used as the mixed stacking index value Z.

As described above, the present embodiment calculates, for each sheet conveyed from the storage unit 13, a variance value of characteristic values detected by the detection device 33 over the predetermined number of continuous sheets, including this sheet. Furthermore, a moving average value of the calculated variance values is calculated as the index value of the mixed stacking state of sheets in the storage unit 13 (the mixed stacking index value).

FIG. 7 shows an example of a change in the mixed stacking index value Z obtained (determined) in the above-described manner relative to the number of counts (page count) obtained by sequentially counting the sheets fed from the storage unit 13. As shown in FIG. 7, it is apparent that the mixed stacking index value Z substantially increases when the page count exceeds each of the page counts K1, K2, and K3, which are equivalent to the positions of the mixed stacking boundaries. This is because, when the type of conveyed sheets changes at a mixed stacking boundary, the variations in characteristic values indicating the grammages and surface properties of the sheets detected by the detection device 33 increase (i.e., the variance values increase).

### <Determination Based on Mixed Stacking Index Value>

Next, a description will be given of the determination made by the control unit 200 based on the aforementioned mixed stacking index value Z. As described above, the mixed stacking index value Z changes significantly at a mixed stacking boundary relative to the number of counts (page count) obtained by sequentially counting the sheets fed from the storage unit 13. Therefore, it is possible to identify a mixed stacking boundary and determine whether or not mixed stacking of sheets has occurred in the storage unit 13 based on a change in the mixed stacking index value Z relative to the page count.

Specifically, as shown in FIG. 7, a difference A between a mixed stacking index value Z_{K1} corresponding to a sheet of a page count K1 and a mixed stacking index value Z_{K1+1} corresponding to a sheet that is fed next is obtained.

$$Δ = {Z}_{K + 1} - {Z}_{K}$$

Furthermore, in a case where the difference A exceeds a predetermined threshold T1 (Δ>T1), the page count K1 is identified as a position of a mixed stacking boundary, and it is also determined that mixed stacking of sheets has occurred in the storage unit 13.

In this way, regarding the sheets that are sequentially conveyed from the storage unit 13, if the difference A between the mixed stacking index value Z_{K1} corresponding to a preceding sheet and the mixed stacking index value Z_{K1+1} corresponding to a succeeding sheet, which is conveyed from the storage unit 13 next to this preceding sheet, exceeds a predetermined threshold, this preceding sheet is identified as a boundary (mixed stacking boundary). Note that in the present example, boundary information indicating a boundary (mixed stacking boundary) is obtained based on a count value (K1, K2, K3, or the like) obtained by counting the sheets sequentially fed from the storage unit 13 as stated earlier. Also, the obtained boundary information may indicate a boundary (mixed stacking boundary) using time information based on a feed timing or a timing detected by the detection device 33 in relation to the sheets sequentially fed from the storage unit 13.

In a case where mixed stacking of sheets has occurred in the storage unit 13, sheets that have a possibility of getting jammed among the stored stack of sheets are sheets that are conveyed collectively from the storage unit 13 due to the mixed stacking of sheets, such as the stack of sheets ST shown in FIG. 3C. Therefore, the present embodiment identifies sections of page counts in which a jam can possibly occur due to mixed stacking of sheets, such as section a, section b, and section c shown in FIG. 7.

Specifically, these sections are each identified as a section between the page count K1, K2, or K3 indicating the position of a mixed stacking boundary in the stack of sheets stored in the storage unit 13, and a page count that precedes the page count K1, K2, or K3 indicating the position of a mixed stacking boundary by a predetermined number (10 in the present example, which is the same as FIGS. 3A to 3D). For example, section a, section b, and section c are respectively identified (set) as a section of K1−10≤a≤K1, a section of K2−10≤b≤K2, and a section of K2−10≤c≤K2.

As described above, in a case where discrete sheets in a sheet stack are sequentially conveyed from the storage unit 13, ranges (section a, section b, and section c) that include a sheet positioned at a boundary indicated by the boundary information (page count K1, K2, or K3) and a predetermined number of (10 in the present example) continuous sheets that are fed from the storage unit 13 immediately before the aforementioned sheet are identified as ranges (sections) of sheets that have a possibility of getting jammed due to mixed stacking of sheets.

Note that the number of sheets included in the stack of sheets ST shown in FIG. 3C (the number of sheets that are conveyed collectively from the storage unit 13 to the nip portion between the feed roller 122 and the separation roller 123) changes in accordance with the types of sheets that are stacked. This is because the coefficient of friction between different types of sheets changes in accordance with the surface properties of these sheets. Therefore, the aforementioned predetermined number that defines section a, section b, and section c is not limited to 10, and can be determined in accordance with the types of sheets.

Among the defects (jams) that occur in the image forming apparatus 100, a defect (jam) caused by mixed stacking of sheets can be discriminated by using the sections of page counts in which a jam can possibly occur due to mixed stacking of sheets in the storage unit 13 (section a, section b, and section c). For example, on the occurrence of a jam of a sheet corresponding to a page count in section a, section b, or section c of FIG. 7, the control unit 200 determines that (there is a high possibility that) the cause of the jam that has occurred is mixed stacking of sheets in the storage unit 13. In this way, a defect (jam) that occurs due to mixed stacking of sheets in the storage unit 13 can be discriminated based on a relationship between the positions of mixed stacking boundaries in a stack of successive sheets that are sequentially fed from the storage unit 13, and the timing of the occurrence of a jam in this stack of sheets.

Note that the basis for the determination of sections in which a jam can possibly occur due to the positions of mixed stacking boundaries and mixed stacking of sheets is not limited to page counts, but can also be a time period that has elapsed since the timing of the start of feeding of the topmost sheet among all sheets stacked in the storage unit 13 (i.e., the first sheet among a stack of successive sheets that are sequentially fed from the storage unit 13).

Furthermore, the accuracy of the aforementioned determination can be increased based on a relationship between the positions of mixed stacking boundaries and the storage unit from which a sheet that has jammed has been fed. For example, in a case where the image forming apparatus 100 includes a plurality of storage units that can each store sheets, the control unit 200 may be configured to execute the following processing. Specifically, even on the occurrence of a jam of a sheet fed from a storage unit other than a storage unit that has been determined to have mixed stacking of sheets, the control unit 200 does not determine mixed stacking of sheets as the cause of the occurrence of the jam. On the other hand, on the occurrence of a jam of a sheet fed from the storage unit that has been determined to have mixed stacking of sheets, the control unit 200 determines that (there is a high possibility that) mixed stacking of sheets is the cause of the occurrence of the jam.

### <Processing for Discriminating Cause of Defect>

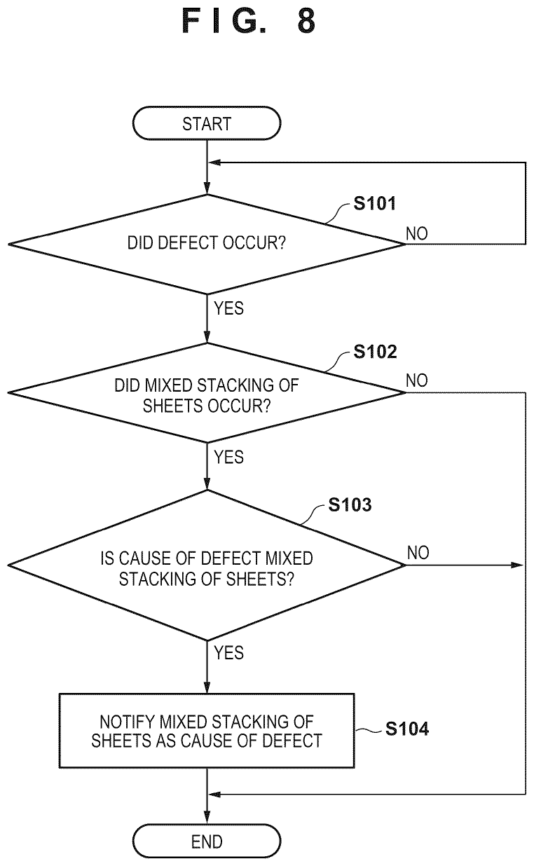

FIG. 8 is a flowchart showing an example of a procedure of processing for discriminating (identifying) the cause of a defect that has occurred in the image forming apparatus 100. The present example will be described in relation to processing for discriminating whether the cause of a defect is mixed stacking of sheets in the storage unit 13 in a case where a sheet jam has occurred as the defect in the image forming apparatus 100. The control unit 200 starts to execute the processing according to the procedure of FIG. 8 when, for example, the execution of an image forming process has been started.

In step S101, the control unit 200 determines whether or not some sort of defect has occurred in the image forming apparatus 100. Examples of defects that can occur include a sheet jam (paper jam) on the conveyance path, an inappropriate temperature in the fixing unit 18, an abnormality in the rotation speeds of the photosensitive drums 1, an abnormality in the rotation speed of the intermediate transfer belt 8, and the like. The control unit 200 determines an operation state (e.g., a state of the occurrence of a defect) of the image forming apparatus 100 based on sheet position information, operation information of each device, and the like. For example, the control unit 200 determines that a sheet jam has occurred upon detecting, based on the sheet position information, that a sheet currently conveyed has not reached a predetermined position by a timing that has been presumed in advance. In accordance with the determination that a defect (e.g., a sheet jam) has occurred, the control unit 200 stops the operation (image forming operation) of the image forming apparatus 100.

The control unit 200 repeats the determination processing of step S101 until it is determined that a defect has occurred (the occurrence of a defect is detected). Upon determining that a defect has occurred (detected the occurrence of a defect), the control unit 200 advances the processing from step S101 to step S102.

In step S102, the control unit 200 determines whether or not mixed stacking of sheets has occurred in the storage unit 13 based on characteristic values indicating physical characteristics (in the present embodiment, grammages and surface properties) of sheets, which are detected by the detection device 33. Specifically, the control unit 200 obtains (determines) a mixed stacking index value (described using FIG. 7) based on the detection results output from the detection device 33. The control unit 200 further determines whether or not mixed stacking of sheets has occurred in the storage unit 13 using the mixed stacking index value as described above. The control unit 200 also identifies mixed stacking boundaries in the stack of sheets that was stored in the storage unit 13 by using the mixed stacking index value. In this way, based on changes in the characteristic values detected by the detection device 33 while discrete sheets in the sheet stack are sequentially conveyed from the storage unit 13, the control unit 200 obtains boundary information indicating boundaries between different types of sheets in the sheet stack that was stored in the storage unit 13.

In a case where the control unit 200 has determined that mixed stacking of sheets has not occurred in the storage unit 13 in step S102, it ends the processing according to the procedure of FIG. 8. On the other hand, in a case where the control unit 200 has determined that mixed stacking of sheets has occurred in the storage unit 13, it advances the processing from step S102 to step S103.

In step S103, the control unit 200 determines whether or not the cause of the defect that has occurred is mixed stacking of sheets in the storage unit 13. This determination processing can be executed based on a relationship between the timing of the occurrence of the defect (jam) (the sheet that has jammed) and the mixed stacking boundaries in the stack of successive sheets that have been sequentially fed from the storage unit 13 as described above. In a case where the control unit 200 has determined that the cause of the defect that has occurred is not mixed stacking of sheets in the storage unit 13 in step S103, it ends the processing according to the procedure of FIG. 8. On the other hand, in a case where the control unit 200 has determined that the cause of the defect that has occurred is mixed stacking of sheets in the storage unit 13, it advances the processing from step S103 to step S104.

In step S104, the control unit 200 executes notification processing for providing a notification that indicates mixed stacking of sheets in the storage unit 13 as the cause of the defect, and ends the processing according to the procedure of FIG. 8. This notification processing may provide a notification that indicates not only the result of discrimination (identification) of the cause of the defect, but also troubleshooting based on the discriminated cause (i.e., a solution to the defect), as will be described later.

Note that in a case where the control unit 200 has determined that mixed stacking of sheets has not occurred in the storage unit 13 (“NO” in step S102), or in a case where it has determined that the cause of the defect is not mixed stacking of sheets (“NO” in step S103), it may provide a notification of information indicating that a defect caused by mixed stacking of sheets has not occurred.

### <Processing for Notification of Cause of Defect>

In the image forming apparatus 100 of the present embodiment, the control unit 200 may execute the following processing as the notification processing (step S104). The control unit 200 provides a notification of the result of discrimination of the defect (step S103) by displaying the same on the operation unit 211 (display unit) of the image forming apparatus 100, or by transmitting the same to an external apparatus (management apparatus 230) capable of communicating with the image forming apparatus 100 via the network.

As shown in FIG. 2, the image forming apparatus 100 is connected to the management apparatus 230 via the network in a communication-enabled manner. The management apparatus 230 can be, for example, a terminal apparatus (information processing apparatus), such as a PC, of an IT management administrator inside an office, or a terminal apparatus or a server apparatus of a maintenance and management company. The management apparatus 230 may include a monitoring tool for monitoring the operations of the image forming apparatus 100 based on information received from the image forming apparatus 100. This monitoring tool may operate as one of processes on the management apparatus 230.

The control unit 200 may display operation information indicating an operation state of the image forming apparatus 100 and defect information including information related to the defect that has occurred, on the operation unit 211 (display unit) of the image forming apparatus 100, or may transmit them to the management apparatus 230 via the network. The management apparatus 230 may display information received from the image forming apparatus 100 on a display unit (not shown) of this management apparatus 230. Furthermore, in a case where the cause of a jam that has occurred has been identified as mixed stacking of sheets in the storage unit 13 as a result of the execution of the above-described discrimination processing (FIG. 8), the control unit 200 displays information indicating this identified cause and information indicating troubleshooting on the operation unit 211 of the image forming apparatus 100.

The management apparatus 230 may, for example, remotely notify a user of the image forming apparatus 100 of a solution to the defect, based on information received from the image forming apparatus 100. The solution to the defect includes, for example, a notification for suggesting that the mixed stacking state of the stack of sheets in the storage unit 13 be dissolved. Furthermore, based on the received information, the management apparatus 230 may execute processing for supplying a periodic replacement unit that has been depleted in the image forming apparatus 100, or may execute processing for issuing an instruction for a dispatch of a maintenance and management company so as to fix a failed part of the image forming apparatus 100.

As described above, the image forming apparatus 100 of the present embodiment includes the detection device 33 that is arranged on the conveyance path and is configured to detect characteristic values indicating physical characteristics (grammage and surface property) of a sheet currently conveyed on the conveyance path from the storage unit 13 toward the image forming units (secondary transfer unit 17). Based on changes in the characteristic values detected by the detection device 33 while discrete sheets in the sheet stack are sequentially conveyed from the storage unit 13, the control unit 200 obtains boundary information indicating boundaries between different types of sheets in the sheet stack that was stored in the storage unit 13. In a case where a defect has occurred in the image forming apparatus 100, the control unit 200 discriminates a defect that occurs due to mixed stacking, which is stacking of a plurality of types of sheets in the storage unit 13, based on the obtained boundary information.

In this way, in the present embodiment, the image forming apparatus 100 discriminates a defect that occurs due to mixed stacking, which is stacking of a plurality of types of sheets in the storage unit 13, based on the boundary information that is obtained based on changes in characteristic values of sheets detected by the detection device 33. Consequently, in a case where a defect (e.g., a sheet jam) caused by mixed stacking of a plurality of types of sheet has occurred, such a cause can be identified (discriminated). This makes it possible to suggest a user of the image forming apparatus 100 to carry out appropriate troubleshooting.

For example, a maintenance and management company can address the defect (jam) that has occurred, without requiring a service dispatch, by suggesting the user of the image forming apparatus 100 to check and dissolve the mixed stacking state of the sheet stack in the storage unit 13 (to store only one type of sheets). In this way, the resolution to the defect can be made efficient.

Note that although the present embodiment has been described in relation to an example in which a mixed stacking index value is obtained using, as characteristic values indicating physical characteristics of the sheet, characteristics indicating the grammage and surface property of a sheet, characteristic values indicating characteristics other than the grammage and surface property may be used. Also, a characteristic value corresponding to one characteristic may be used, or characteristic values corresponding to three or more characteristics may be used. Furthermore, the cause of a defect that has occurred in the image forming apparatus 100 may be identified by an external apparatus (e.g., a server apparatus) capable of communicating with the image forming apparatus 100.

### Second Embodiment

The first embodiment has been described in relation to an example in which a mixed stacking index value is obtained based on characteristic values indicating physical characteristics of sheets detected by the detection device 33. A second embodiment will be described in relation to an example in which a mixed stacking index value is obtained using a conveyance sensor arranged on a conveyance path of sheets. Hereinafter, a description of components that overlap with the first embodiment will be omitted by using the same reference signs therefor.

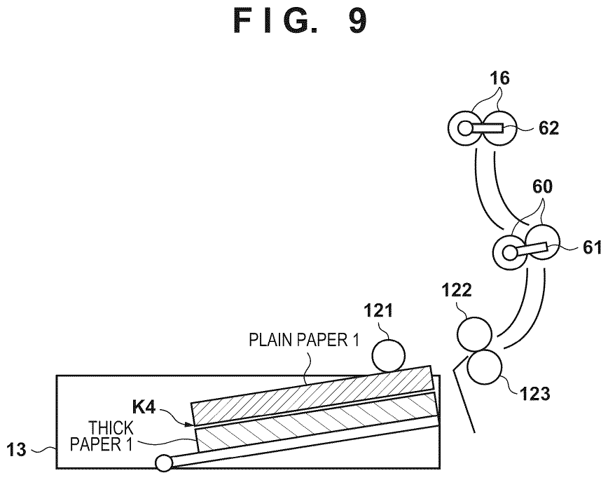

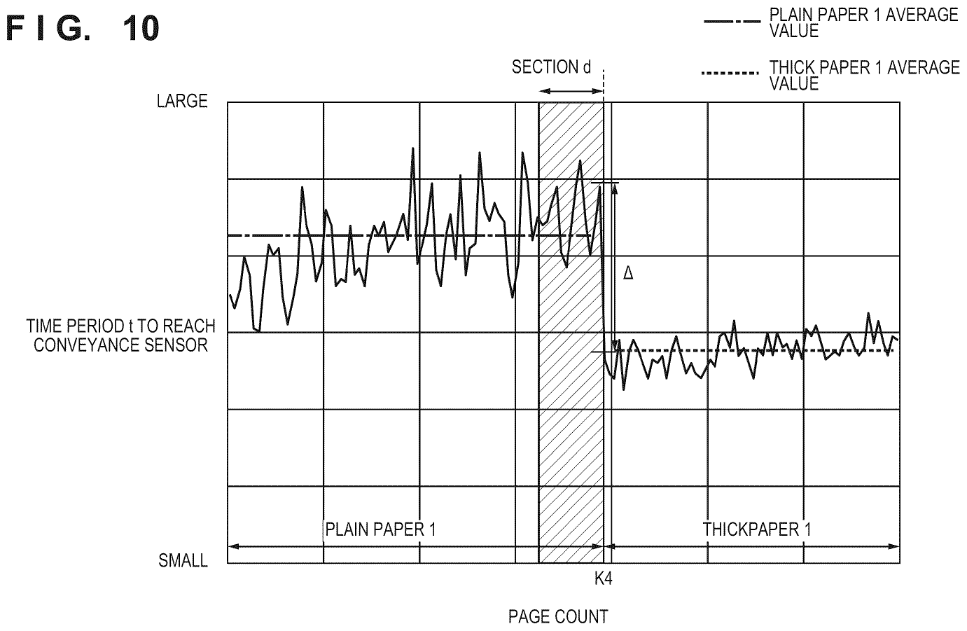

FIG. 9 is a cross-sectional diagram of exemplary components in the vicinity of the storage unit 13 and the feeding unit 12 in the image forming apparatus 100, and shows an example of a mixed stacking state of sheets inside the storage unit 13, which is the premise of the following description. In the present example, two different types of sheets are mixedly stacked inside the storage unit 13. Specifically, as shown in FIG. 9, a stack of sheets of thick paper 1 is loaded at the bottom, and a stack of sheets of plain paper 1 is stacked thereon in such a manner that the stacks overlie each another. K4 shown in FIG. 9 is a page count corresponding to the lowermost sheet (the sheet that is fed last) among the stack of sheets of plain paper 1, and indicates a boundary (mixed stacking boundary) between the stack of sheets of plain paper 1 and the stack of sheets of thick paper 1.

A sheet fed from the storage unit 13 is conveyed by the feed roller 122 through the conveyance path formed by a conveyance guide, directed to a nip portion of a conveyance roller pair 60, and detected by a conveyance sensor 61. The conveyance sensor 61 is arranged in the vicinity of the nip portion of the conveyance roller pair 60, and in the vicinity of a curved portion of the conveyance path. The sheet that has passed through the position of the conveyance sensor 61 is conveyed by the conveyance roller pair 60 on the conveyance path formed by the conveyance guide, and reaches the position of the registration roller pair 16. A registration shutter 62 is arranged in the vicinity of a nip portion of the registration roller pair 16. The registration shutter 62 corrects oblique passage of the sheet conveyed on the conveyance path. Thereafter, the registration roller pair 16 conveys the sheet to the secondary transfer unit 17, which is located downstream in the conveyance direction, at a predetermined control timing.

A clearance of, for example, approximately 3 to 4 mm in the direction of sheet thickness is formed in the conveyance path inside the image forming apparatus 100. Such a clearance is provided to enable the image forming apparatus 100 to stably convey a variety of types of sheets with different thicknesses, from sheets of thin paper to sheets to thick paper. If the conveyance path has an extremely small clearance in the direction of sheet thickness, conveyance resistance increases in the conveyance path, especially when sheets of thick paper are conveyed. This increases the possibility of occurrence of a jam due to a delay in sheet conveyance. Conversely, if the conveyance path has an extremely large clearance in the direction of sheet thickness, sheets flap in the conveyance path, especially when sheets of thin paper are conveyed. This causes variations in the timings of arrival of sheets at the conveyance sensor 61, thereby making sheet conveyance control difficult. For this reason, a clearance of, for example, approximately 3 to 4 mm is generally formed as a clearance of the conveyance path in the direction of sheet thickness.

However, even if a clearance of approximately 3 to 4 mm is formed as a clearance of the conveyance path in the direction of sheet thickness, sheets with different grammages do not necessarily take the same route inside the conveyance path in a case where such sheets are conveyed. For example, in a case where a sheet of thick paper that is high in sheet stiffness is conveyed, after the start of the conveyance by the feed roller 122, this sheet tends to take the shortest route connecting between a nip portion of a roller pair and a nip portion of the next roller pair on the conveyance path. On the other hand, in the case of plain paper or thin paper, the sheet stiffness is relatively low; thus, after the start of conveyance of a sheet by the feed roller 122, this sheet takes a route of transportation along the conveyance guide.

Therefore, a time period required from the start of the pickup operation for a sheet by the pickup roller 121 to arrival of this sheet at the conveyance sensor 61 varies between a case where this sheet is a sheet of plain paper and a case where this sheet is a sheet of thick paper. That is to say, this required time period changes in accordance with a type of a conveyed sheet (physical characteristics of the sheet).

FIG. 10 shows examples of changes in a time period t from the start of feeding of a sheet to arrival of the sheet at the conveyance sensor 61 on the conveyance path. A vertical axis indicates a time period required from the start of the pickup operation to arrival of the sheet at the conveyance sensor 61 (a time period t), and a horizontal axis indicates a page count. The present example corresponds to a case where a stack of sheets of thick paper 1 and a stack of sheets of plain paper 1 are mixedly stacked and the sheets have been sequentially fed, one by one, starting from the topmost sheet, as shown in FIG. 9.

In the present embodiment, using the output from the conveyance sensor 61, the control unit 200 measures a time period (a time period t) required to convey the sheet in a predetermined section on the conveyance path (in the present example, a section from the position of the storage unit 13 to the position of the conveyance sensor 61. The control unit 200 obtains boundary information indicating a boundary between different types of sheets in the sheet stack that was stored in the storage unit 13 based on changes in the measured time period (time period t).

Specifically, it is assumed that a time period t corresponding to a sheet of a page count K4 shown in FIG. 10 is t_{K4}, and a difference A between a time period t_{K4} and a time period t_{K4+1} corresponding to a sheet that is fed next (a sheet of a page count K4+1) is obtained. A is expressed by the following formula.

$$Δ = \vert {t}_{K 4 + 1} - {t}_{K 4} \vert$$

Furthermore, in a case where the difference A exceeds a predetermined threshold T (Δ>T2), the page count K1 is determined to be a mixed stacking boundary, and it is also determined that mixed stacking of sheets has occurred in the storage unit 13. In this way, it is determined that mixed stacking of sheets has occurred in the storage unit 13 in a case where the time period t has changed substantially. Also, the page count K4 at this time is obtained as boundary information indicating the mixed stacking boundary.

In a case where mixed stacking of sheets has occurred in the storage unit 13, a section of page counts in which a jam can possibly occur due to mixed stacking of sheets (section d of FIG. 10) is identified, similarly to the first embodiment. That is to say, section d is set as K4−10≤d≤K4. Similarly to the first embodiment, among the defects (jams) that occur in the image forming apparatus 100, a defect (jam) caused by mixed stacking of sheets can be discriminated by using the section of page counts in which a jam can possibly occur due to mixed stacking of sheets (section d).

Note that the registration shutter 62 also plays a role as a registration conveyance sensor, and is used in detection of sheet conveyance timings. In view of this, a time period required to convey a sheet from the conveyance sensor 61 to the registration shutter 62 (registration conveyance sensor) may be used in place of the above-described time period t until the sheet reaches the conveyance sensor 61.

The image forming apparatus 100 (control unit 200) of the present embodiment executes processing for discriminating (identifying) the cause of a defect that has occurred in the image forming apparatus 100, similarly to the first embodiment (FIG. 8). In the present embodiment, in a case where a defect, such as a jam, has occurred at a page count in the above-described section d, the cause of this defect is assumed to be mixed stacking of sheets in the storage unit 13, and the notification processing (S104) is executed.

Note that even in a case where a defect has not occurred, if it has been determined that there has been mixed stacking of sheet stacks that were stored in the storage unit 13, the notification processing may be executed in relation to the result of this determination. In this case, a notification can be provided indicating that, although a defect has not occurred in the image forming apparatus 100, the image forming apparatus 100 has been used in a state where there has been mixed stacking of sheet stacks that were stored in the storage unit 13. In this way, a user or a maintenance and management company can be informed to the effect that there is a possibility of occurrence of a defect caused by mixed stacking of sheets in the storage unit 13. This can lead to alerting, or obviating the occurrence of a defect.

As described above, the image forming apparatus 100 of the present embodiment includes the conveyance sensor 61 (a first sensor) which is arranged in the vicinity of a curved portion of the conveyance path, and which detects a sheet currently conveyed on the conveyance path from the storage unit 13 toward the image forming units (secondary transfer unit 17). The control unit 200 obtains boundary information indicating a boundary between different types of sheets in a sheet stack that was stored in the storage unit 13, based on changes in a time period which is required to convey a sheet in a predetermined section of the conveyance path, and which is measured using the output from the conveyance sensor 61. In a case where a defect has occurred in the image forming apparatus 100, the control unit 200 discriminates a defect that occurs due to mixed stacking, which is stacking of a plurality of types of sheets in the storage unit 13, based on the obtained boundary information.

In the present embodiment, the aforementioned predetermined section is a section from the position of the storage unit 13 to the position of the conveyance sensor 61 (first sensor) on the conveyance path. Alternatively, the predetermined section may be a section from the position of the conveyance sensor 61 (the first sensor) to the position of the registration shutter 62 (a second sensor) on the conveyance path.

According to the present embodiment, in a case where a defect (e.g., a sheet jam) caused by mixed stacking of a plurality of types of sheet has occurred, such a cause can be identified (discriminated), similarly to the first embodiment. This makes it possible to suggest a user of the image forming apparatus 100 to carry out appropriate troubleshooting.

As described above, according to various embodiments of the present disclosure, in a case where a defect has occurred in the image forming apparatus, a defect caused by mixed stacking of sheets in the storage unit can be discriminated.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-120925, filed Jul. 25, 2023, which is hereby incorporated by reference herein in its entirety.

What is claimed is:

1. An image forming apparatus, comprising:
a storage unit in which a sheet stack is stored;
an image forming unit configured to form an image on a sheet conveyed from the storage unit via a conveyance path;
a detection unit arranged on the conveyance path, and configured to detect a characteristic value indicating a physical characteristic of a sheet currently conveyed on the conveyance path from the storage unit toward the image forming unit;
an obtainment unit configured to obtain boundary information based on a change in the characteristic value detected by the detection unit while discrete sheets in the sheet stack are sequentially conveyed from the storage unit, the boundary information indicating a boundary between different types of sheets in the sheet stack that has been stored in the storage unit; and
a discrimination unit configured to, in a case where a defect has occurred in the image forming apparatus, discriminate a defect that occurs due to mixed stacking based on the boundary information obtained by the obtainment unit, the mixed stacking being stacking of a plurality of types of sheets in the storage unit.

2. The image forming apparatus according to claim 1, further comprising
a notification unit configured to provide a notification indicating a result of the discrimination of the defect by the discrimination unit by displaying the result on a display unit of the image forming apparatus, or by transmitting the result to an external apparatus capable of communicating with the image forming apparatus via a network.

3. The image forming apparatus according to claim 1, wherein
the discrimination unit discriminates the defect that occurs due to the mixed stacking based on a relationship between a timing of the occurrence of the defect and the boundary in the sheet stack indicated by the boundary information.

4. The image forming apparatus according to claim 3, wherein
the discrimination unit identifies, as a range of sheets that have a possibility of getting jammed due to the mixed stacking, a range that includes a sheet located at the boundary indicated by the boundary information and a predetermined number of continuous sheets that are fed from the storage unit immediately before the sheet, in a case where the discrete sheets in the sheet stack are sequentially conveyed from the storage unit.

5. The image forming apparatus according to claim 4, wherein
in a case where a sheet included in the range has jammed among the sheet stack that has been stored in the storage unit, the discrimination unit identifies the mixed stacking as a cause of the occurrence of the jam.

6. The image forming apparatus according to claim 1, wherein
the obtainment unit
calculates, for each sheet conveyed from the storage unit, a variance value of characteristic values that have been detected by the detection unit over a predetermined number of continuous sheets including the sheet, and calculates a moving average value of the calculated variance value as an index value of a mixed stacking state of sheets in the storage unit, and
identifies the boundary in the sheet stack that has been stored in the storage unit based on changes in the index values corresponding to sheets that are sequentially conveyed from the storage unit.

7. The image forming apparatus according to claim 6, wherein
regarding the sheets that are sequentially conveyed from the storage unit, when a difference between the index value corresponding to a preceding sheet and the index value corresponding to a succeeding sheet that is conveyed from the storage unit next to the preceding sheet exceeds a predetermined threshold, the obtainment unit identifies the preceding sheet as the boundary.

8. The image forming apparatus according to claim 7, wherein
the boundary information indicates the boundary in accordance with a count value obtained by counting sheets that are sequentially fed from the storage unit.

9. The image forming apparatus according to claim 7, wherein
the boundary information indicates the boundary in accordance with time information based on feed timings for sheets that are sequentially fed from the storage unit, or based on timings detected by the detection unit.

10. The image forming apparatus according to claim 1, wherein
the detection unit detects a characteristic value indicating a grammage of a sheet.

11. The image forming apparatus according to claim 1, wherein
the detection unit detects a characteristic value indicating a surface property of a sheet.

12. The image forming apparatus according to claim 2, wherein
the notification unit provides a notification indicating not only the result of the discrimination of the defect, but also troubleshooting for resolving the defect based on the result of the discrimination.

13. An image forming apparatus, comprising:
a storage unit in which a sheet stack is stored;
an image forming unit configured to form an image on a sheet conveyed from the storage unit via a conveyance path;
a first sensor arranged in a vicinity of a curved portion of the conveyance path, the first sensor detecting a sheet currently conveyed on the conveyance path from the storage unit toward the image forming unit;
an obtainment unit configured to obtain boundary information based on a change in a time period which is required to convey a sheet in a predetermined section of the conveyance path and which is measured using an output from the first sensor, the boundary information indicating a boundary between different types of sheets in the sheet stack that has been stored in the storage unit; and
a discrimination unit configured to, in a case where a defect has occurred in the image forming apparatus, discriminate a defect that occurs due to mixed stacking based on the boundary information obtained by the obtainment unit, the mixed stacking being stacking of a plurality of types of sheets in the storage unit.

14. The image forming apparatus according to claim 13, wherein
the predetermined section is a section from a position of the storage unit to a position of the first sensor on the conveyance path.

15. The image forming apparatus according to claim 13, further comprising
a second sensor arranged downstream relative to the first sensor in a sheet conveyance direction on the conveyance path, the second sensor detecting a sheet currently conveyed on the conveyance path from the storage unit toward the image forming unit,
wherein the predetermined section is a section from a position of the first sensor to a position of the second sensor on the conveyance path.

16. A management system, comprising:
an image forming apparatus; and
a management apparatus that is capable of communicating with the image forming apparatus via a network and manages the image forming apparatus,
wherein the image forming apparatus comprises:
a storage unit in which a sheet stack is stored;
an image forming unit configured to form an image on a sheet conveyed from the storage unit via a conveyance path;
a detection unit arranged on the conveyance path, and configured to detect a characteristic value indicating a physical characteristic of a sheet currently conveyed on the conveyance path from the storage unit toward the image forming unit;
an obtainment unit configured to obtain boundary information based on a change in the characteristic value detected by the detection unit while discrete sheets in the sheet stack are sequentially conveyed from the storage unit, the boundary information indicating a boundary between different types of sheets in the sheet stack that has been stored in the storage unit; and
a discrimination unit configured to, in a case where a defect has occurred in the image forming apparatus, discriminate a defect that occurs due to mixed stacking based on the boundary information obtained by the obtainment unit, the mixed stacking being stacking of a plurality of types of sheets in the storage unit, and
wherein the image forming apparatus further includes a notification unit configured to notify the management apparatus of the result of the discrimination of the defect by the discrimination unit.
